(19) United States
(12) Patent Application Publication
(10) Pub. No.: US 2014/0353329 A1
(43) Pub. Date: Dec. 4, 2014

(54) APPARATUSES FOR DISPENSING OBJECTS AND METHODS OF MANUFACTURING AND USES THEREOF

(71) Applicant: Intralot S.A. - Integrated Lottery Systems and Services, Athens (GR)

(72) Inventors: George Plakas, Athens (GR); Ilias Alexopoulos, Athens (GR); Nikos Angelopoulos, Athens (GR); George Dimitrakopoulos, Athens (GR); Apostolos Dalas, Athens (GR)

(21) Appl. No.: 14/293,972

(22) Filed: Jun. 2, 2014

Related U.S. Application Data
(60) Provisional application No. 61/829,850, filed on May 31, 2013.

(51) Int. Cl. G07F 11/04

(52) U.S. Cl. CPC G07F 11/045
USPC 221/124; 29/428

(57) ABSTRACT

In some embodiments, the present invention is directed to a vending machine which includes at least the following components: at least one pocket-dispenser combination within an interior of the vending machine; where the at least one pocket-dispenser combination comprises: i) a plurality of pockets and ii) at least one dispenser; and where the plurality of pockets are vertically positioned during a dispensing operation of the vending machine so that: i) each of the plurality of pockets longitudinally extends along a vertical axis of the vending machine, and ii) equal distances are maintained between bottoms of the plurality of pockets and the at least one dispenser, where the bottoms of the plurality of pockets face down during the dispensing operation of the vending machine.

### RELATED APPLICATIONS

This application claims the benefit of U.S. Provisional Application No. 61/829,850, entitled “METHODS AND SYSTEM FOR DISPENSING OBJECTS,” filed May 31, 2013, which is hereby incorporated by reference herein in its entirety for all purposes.

### TECHNICAL FIELD

The instant invention relates to apparatuses for dispensing objects such as lottery tickets and methods of manufacturing and uses thereof.

### BACKGROUND

Methods and systems for dispensing objects such as lottery tickets are known.

### SUMMARY OF INVENTION

In some embodiments, the present invention is directed to a method that includes at least manufacturing a plurality of vending machines which are utilized to dispense a plurality of dispensing objects; where the manufacturing at least includes steps of: installing a first predetermined number of first pocket-dispenser combinations within a first interior of at least one first vending machine; where each first pocket-dispenser combination which at least includes: i) a first plurality of first pockets and ii) at least one first dispenser; where the first plurality of first pockets are vertically positioned during a dispensing operation of the at least one first vending machine so that: i) each of first pockets longitudinally extends along a first vertical axis of the at least one first vending machine, and ii) equal distances are maintained between bottoms of the first plurality of first pockets and the at least one first dispenser, where the bottoms of the first plurality of first pockets face down during the dispensing operation of the at least one first vending machine; where the first predetermined number is at least one; where a first length and a first width of a first footprint of the at least one first vending machine varies based on the first predetermined number of the first pocket-dispenser combinations to be installed within the first interior of the at least one first vending machine; installing a second predetermined number of second pocket-dispenser combinations within a second interior of at least one second vending machine; where each second pocket-dispenser combination which at least includes: i) a second plurality of second pockets and ii) at least one second dispenser; where the second plurality of second pockets are vertically positioned during a dispensing operation of the at least one second vending machine so that: i) each of second pockets longitudinally extends along a second vertical axis of the at least one second vending machine, and ii) equal distances are maintained between bottoms of the second plurality of second pockets and the at least one second dispenser, where the bottoms of the second plurality of second pockets face down during the dispensing operation of the at least one second vending machine; where the second predetermined number is at least one; where a second length and a second width of a second footprint of the at least one second vending machine varies based on the second predetermined number of the second pocket-dispenser combinations to be installed within the second interior of the at least one second vending machine; where, when the first predetermined number is equal to the second predetermined number, the first footprint is equal to the second footprint; and where, when the first predetermined number is different from the second predetermined number, the first footprint is different from the second footprint.

In some embodiments, the at least one first pocket-dispenser combination further includes at least: a first holding tray, a first subset of the first plurality of first pockets attached to a first side of the first holding tray, a second subset of the first plurality of first pockets attached to a second side of the first holding tray, the at least one first dispenser operationally associated with the first subset of the first plurality of first pockets, and at least one third dispenser operationally associated with the second subset of the first plurality of first pockets.

In some embodiments, the at least one second pocket-dispenser combination includes at least: a second holding tray, a third subset of the second plurality of second pockets attached to a first side of the second holding tray, a fourth subset of the second plurality of second pockets attached to a second side of the second holding tray, the at least one second dispenser operationally associated with the third subset of the second plurality of second pockets, and at least one fourth dispenser operationally associated with the fourth subset of the second plurality of second pockets.

In some embodiments, the dispensing objects are a first plurality of items selected from the group of lottery tickets, drawing tickets, game tickets, or any combination thereof.

In some embodiments, the first plurality of items includes a first subset of the first plurality of items to be dispensed by a first subset of the first plurality of first pockets, and a second subset of the first plurality of items to be dispensed by a second subset of the first plurality of first pockets; and where the first subset of the first plurality of items and the second subset of the first plurality of items are distinct items.

In some embodiments, the first plurality of items includes a first subset of the first plurality of items to be dispensed by a first subset of the second plurality of second pockets, and a second subset of the first plurality of items to be dispensed by a second subset of the second plurality of second pockets; and where the first subset of items and the second subset of items are distinct items.

In some embodiments, each first pocket-dispenser combination and each second pocket-dispenser combination are configured to be rotatable to facilitate an access for placing the plurality of dispensing objects into the first plurality of first pockets and the second plurality of second pockets.

In some embodiments, each first pocket-dispenser combination and each second pocket-dispenser combination further comprise flexible fingers.

In some embodiments, the present invention is directed to a vending machine which includes at least the following components: at least one pocket-dispenser combination within an interior of the vending machine; where the at least one pocket-dispenser combination comprises: i) a plurality of pockets and ii) at least one dispenser; and where the plurality of pockets are vertically positioned during a dispensing operation of the vending machine so that: i) each of the plurality of pockets longitudinally extends along a vertical axis of the vending machine, and ii) equal distances are maintained between bottoms of the plurality of pockets and the at least one dispenser, where the bottoms of the plurality of pockets face down during the dispensing operation of the vending machine.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIG. 1 illustrates features of some embodiments of the present invention.

FIG. 2 illustrates features of some embodiments of the present invention.

FIG. 3 illustrates features of some embodiments of the present invention.

FIG. 4 illustrates features of some embodiments of the present invention.

FIG. 5 illustrates features of some embodiments of the present invention.

FIG. 6A illustrates features of some embodiments of the present invention.

FIG. 6B illustrates features of some embodiments of the present invention.

FIG. 6C illustrates features of some embodiments of the present invention.

FIG. 6D illustrates features of some embodiments of the present invention.

FIG. 6E illustrates features of some embodiments of the present invention.

FIG. 6F illustrates features of some embodiments of the present invention.

FIG. 7A illustrates features of some embodiments of the present invention.

FIG. 7B illustrates features of some embodiments of the present invention.

FIG. 8A illustrates features of some embodiments of the present invention.

FIG. 8B illustrates features of some embodiments of the present invention.

FIG. 9 illustrates features of some embodiments of the present invention.

FIG. 10 illustrates features of some embodiments of the present invention.

FIG. 11 illustrates features of some embodiments of the present invention.

FIG. 12 illustrates features of some embodiments of the present invention.

FIG. 13 illustrates features of some embodiments of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Illustrative Operating Environments

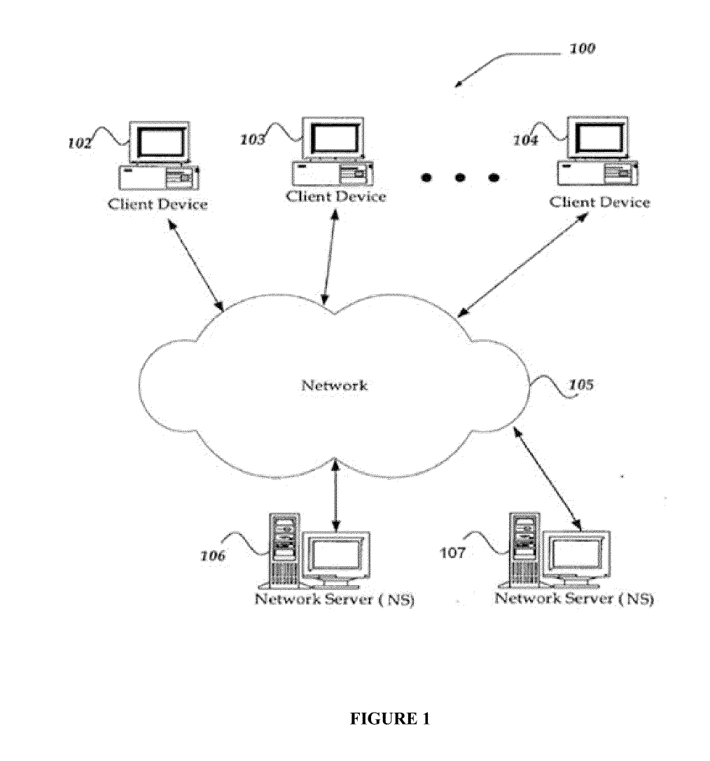

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members and/or concurrent transactions. In other embodiments, the inventive system and method are based on a scalable computer and network architecture that incorporates varies strategies for assessing the data, caching, searching, and database connection pooling. An example of the scalable architecture is an architecture that is capable of operating multiple servers.

In embodiments, members of the inventive computer system 102-104 (e.g. dispensing systems such as vending machines) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, the invention is programmed in either Java, .Net, QT, C, C++ or other suitable programming language.

In embodiments, member devices 102-104 may be further configured to receive a message from another computing device employing another mechanism, including, but not limited to email, Short Message Service (SMS), Multimedia Message Service (MMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

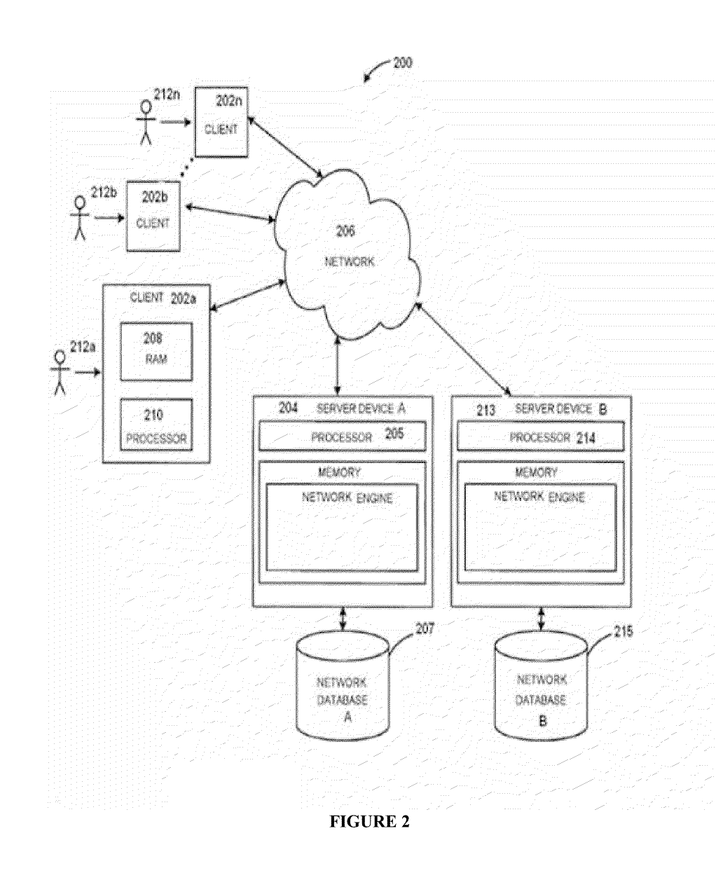

FIG. 2 shows another exemplary embodiment of the computer and network architecture that supports the inventive method and system. The member devices 202a, 202b thru 202n shown (e.g., vending machines) each at least includes a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users (e.g. players, agents, etc.) 212a-n communicate over the network 206 with each other and with other systems and devices coupled to the network 206. As shown in FIG. 2, server devices 204 and 213 may be also coupled to the network 206.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, tablet computer, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

### Illustrative Examples of the Present Invention

In some embodiments, the present invention includes a method and system for dispensing objects such as lottery tickets. One embodiment of the present invention relates to methods and a system for dispensing objects such as tickets (e.g. instant lottery tickets), paper products, and, in general, to any item and/or item in a packaging which one of ordinary skills recognizes to be suitable for a machine-controlled dispensation.

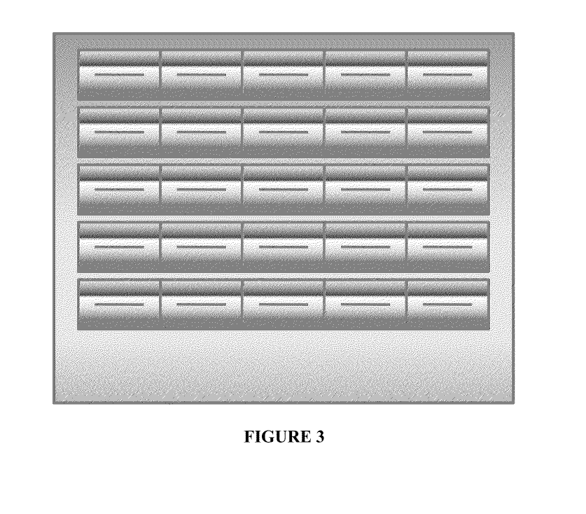

Current instant ticket lottery vending machines which support many objects have a fixed footprint. Traditional vending machines typically include multichannel horizontal ticket storage areas or drawers that provide lottery tickets to the customers as shown in FIG. 3. As used herein, “horizontal” refers to a ticket storage area that is positioned about parallel to a line normal to the planar surface of the dispensing system or vending machine. Horizontal ticket storage areas are also referred to as “drawers”. As used herein, “vertical” refers to a ticket storage area that is positioned about perpendicular—about 60 to 120 degrees—to a line normal to the planar surface of the dispensing system or vending machine. Vertical ticket storage areas are also referred to as “ticket pockets”.

Due to the orientation of the drawers of the traditional vending machines, reduction in the number of drawers and thus the number of objects or tickets results in a reduction in the height of the machine, but does not affect the fixed footprint—i.e., length, width or depth—of the machine. Traditional vending machines typically include 20 to 25 different tickets.

In some embodiments, the present invention is a method and system of dispensing objects using vertical ticket storage areas or ticket pockets. In some embodiments, the ticket pockets include objects such as drawing and/or instant lottery tickets.

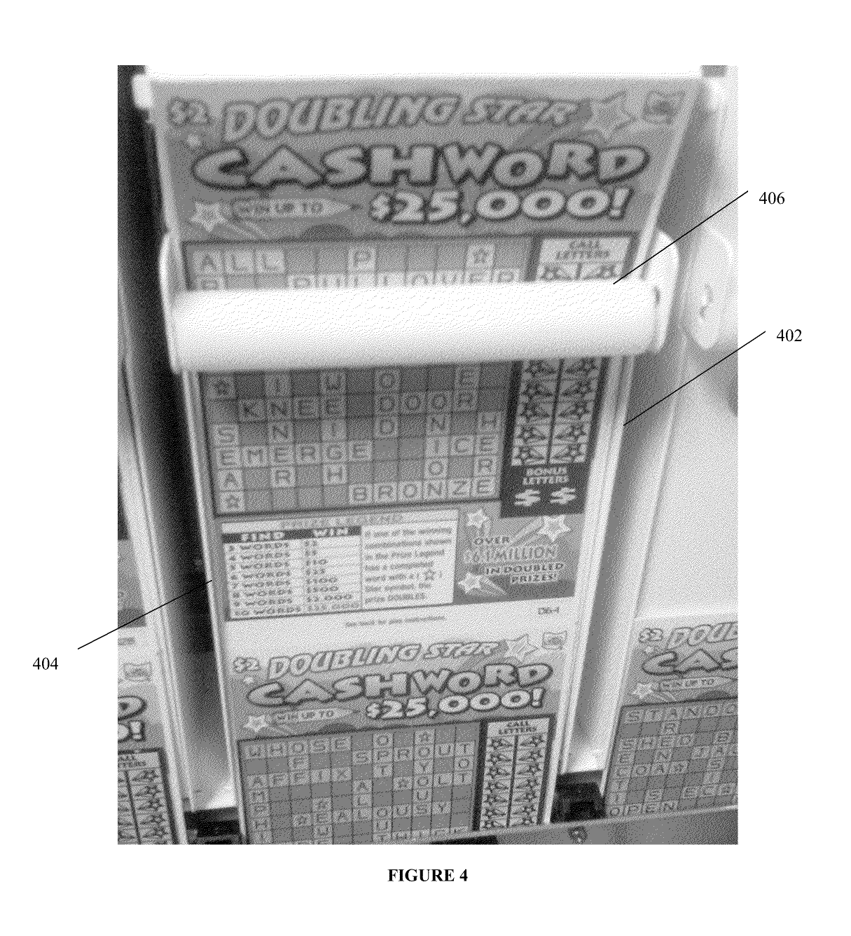

In some embodiments, the objects are positioned in a vertical orientation in the ticket pockets. In some embodiments, the objects are positioned as a ticket stack and/or ticket roll in the ticket pockets. In some embodiments, the ticket pockets may define a predetermined, integrated ticket path as shown on FIG. 4. In some embodiments, the predetermined ticket path may be defined by ticket guides 402, 404 that may be arranged on one or both sides of the ticket path to prevent “skewing” of the tickets during dispensing. In some embodiments, the ticket path may include a horizontal bar, 406 or equivalent that serves to provide the ticket pockets for guiding the tickets during dispensing. In some embodiments, the horizontal bar, 406, may rotate to facilitate dispensing of the objects.

In some embodiments, the ticket pockets are positioned in various orientations in the dispensing system based, at least in part, on the space available for the dispensing system. In some embodiments, the ticket pockets are positioned in the dispensing system to reduce the footprint of the dispensing system. In some embodiments, the ticket pockets are positioned in the dispensing system to facilitate replacement and/or replenishment of the objects.

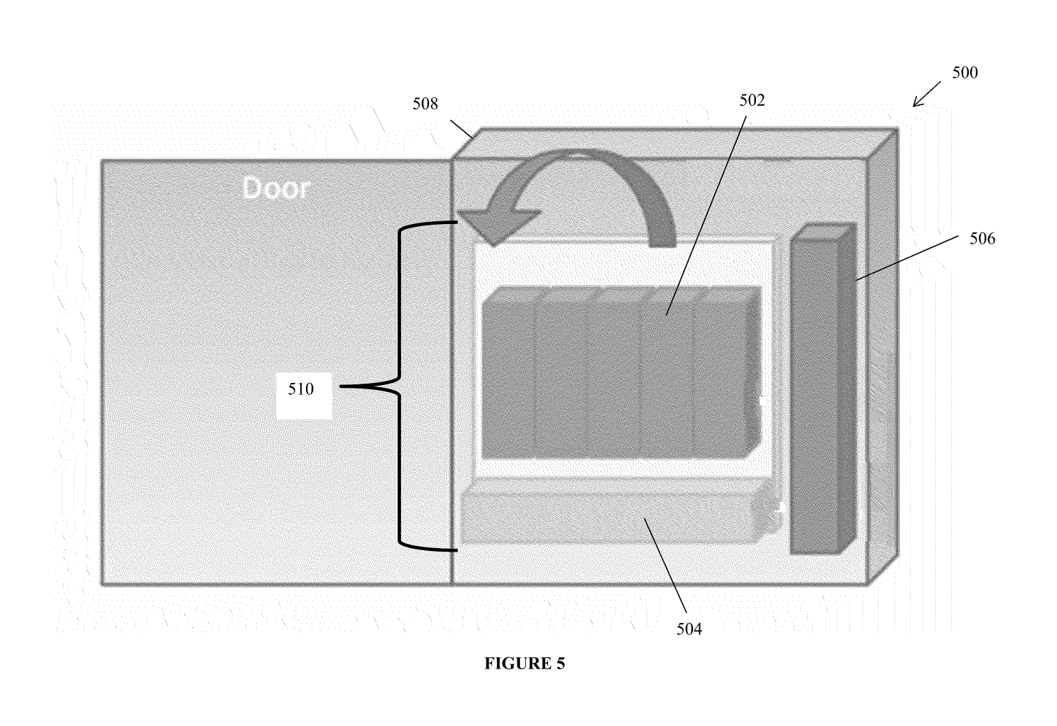

In some embodiments, the ticket pockets are positioned in the dispensing system as shown in FIG. 5 (referred hereinafter as Case A1). As shown in FIG. 5, in some embodiments, one or more ticket pockets 502 are vertically positioned in the dispensing system 500. In some embodiments, the dispensing system may include one or more dispensers 504 for dispensing the objects from the ticket pockets 502. In some embodiments, the dispensing system may also include a payment and validation device 506 configured for receiving payment for the objects.

In some embodiments, one dispenser 504 may be associated with one or more ticket pockets 502. In some embodiments, one dispenser may be associated with 1 to 5 ticket pockets 502. In some embodiments, one dispenser may be associated with 2-4 ticket pockets 502. In some embodiments, one dispenser may be associated with 3 ticket pockets 502. In some embodiments, one dispenser may be associated with 5 ticket pockets 502 as shown on FIG. 5.

In some embodiments, more than one ticket pocket/dispenser combination 510 may be installed in the dispensing system. In some embodiments, the one or more ticket pocket/dispenser combinations 510 may be positioned front to back thus reducing the depth of the dispensing system. In some embodiments, the dispensing system may include 1-6 ticket pocket/dispenser combinations 510. In some embodiments, the dispensing system may include 2-4 ticket pocket/dispenser combinations 510. In some embodiments, the dispensing system may include 2 ticket pocket/dispenser combinations 510. In some embodiments, the dispensing system may include 4 ticket pocket/dispenser combinations 510.

In some embodiments, as shown on FIG. 5, the one or more ticket pocket/dispenser combinations 510 may be secured to the body 508 of the dispensing system via a hinge or equivalent (not shown). In some embodiments, the one or more ticket pocket/dispenser combinations 510 may be rotated from a vertical orientation to a horizontal orientation or via a hinge to facilitate replacement and/or replenishment of the objects as shown by the arrow in FIG. 5. In some embodiments, the one or more ticket pocket/dispenser combinations 510 may be rotated from a vertical orientation to an orientation ranging from 0 to 90 degrees from a line normal to the planar surface of the dispensing system via a hinge to facilitate replacement and/or replenishment of the objects.

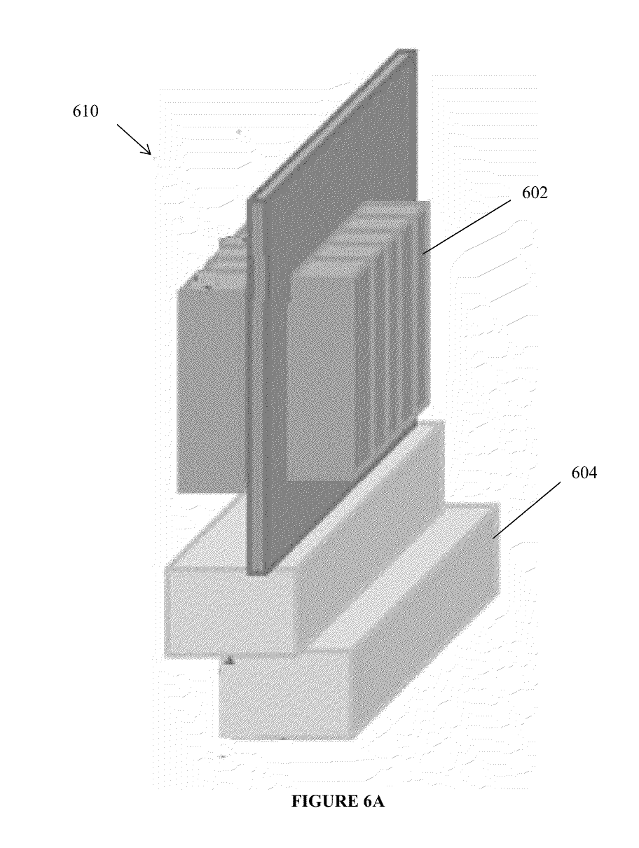

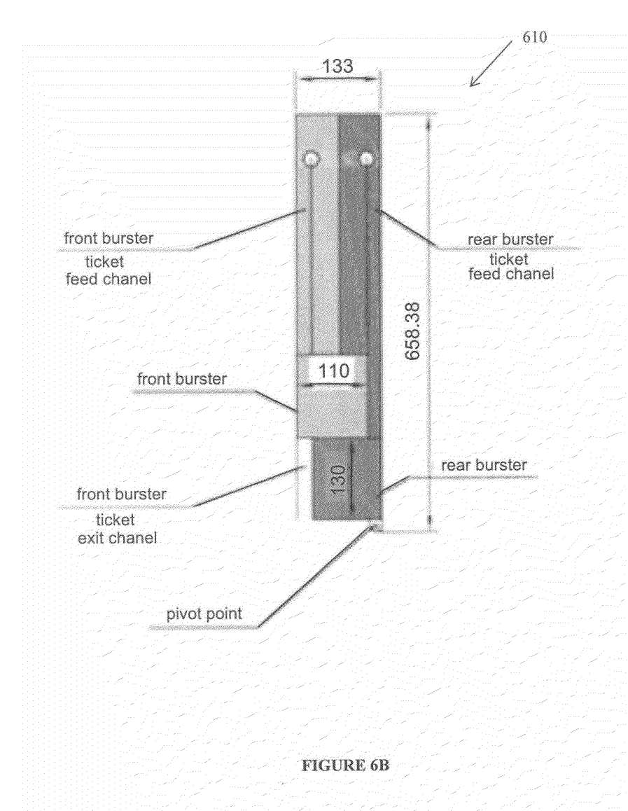

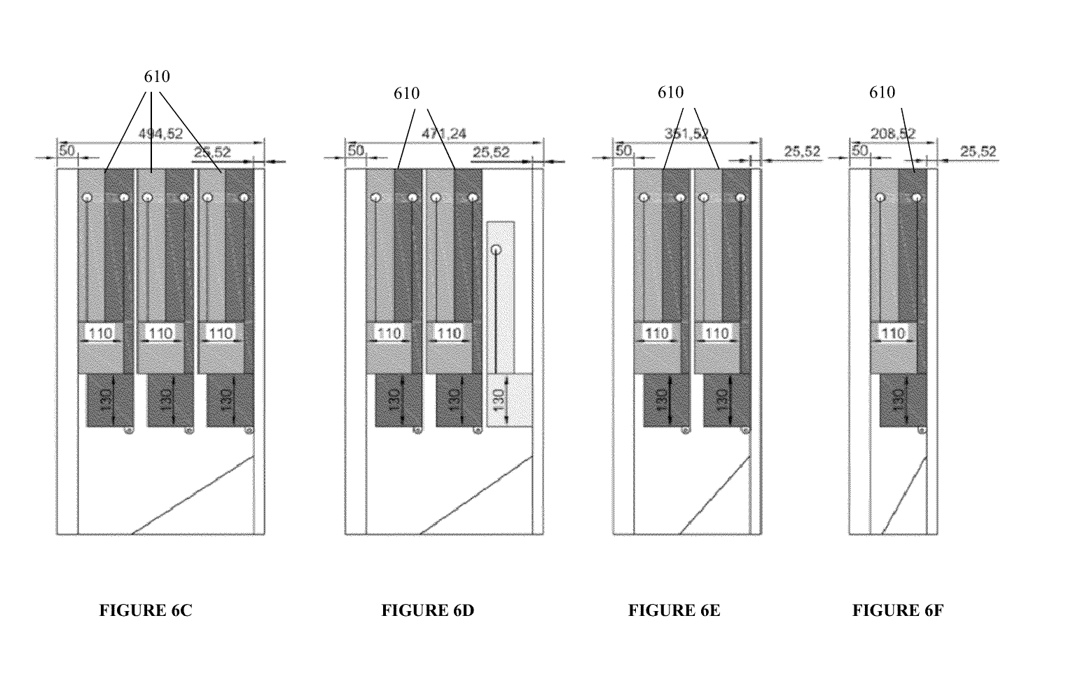

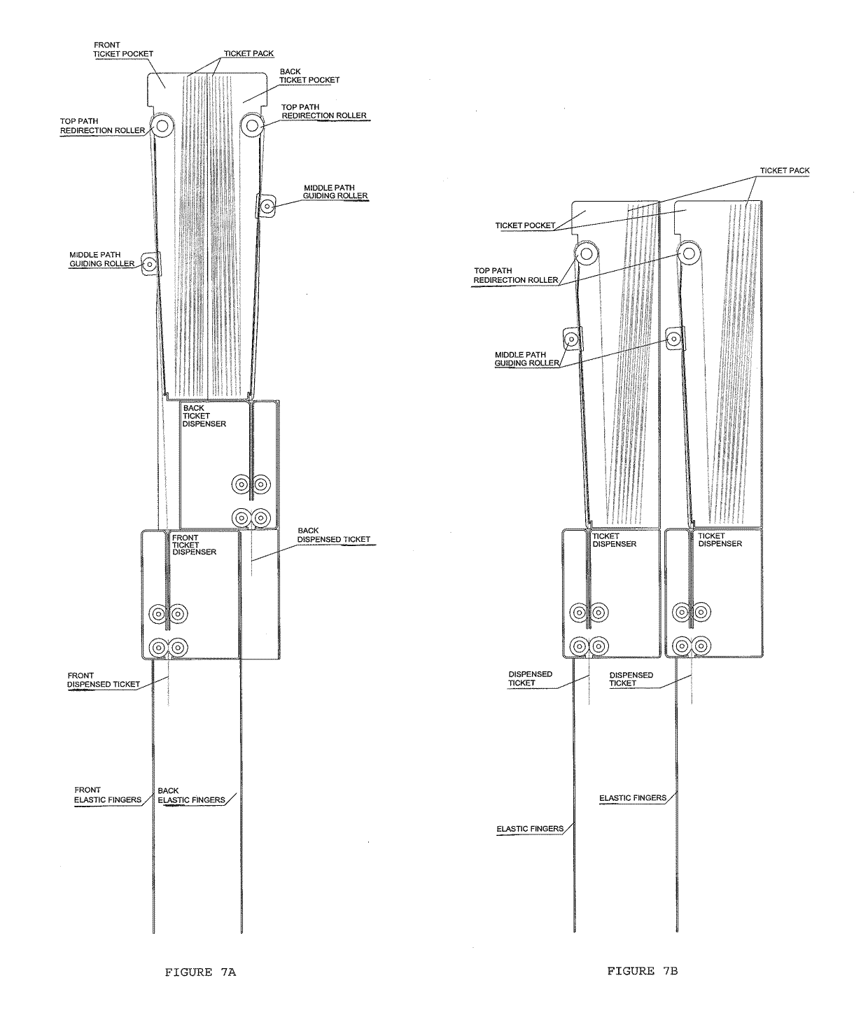

In some embodiments, the ticket pockets are positioned in the dispensing system as shown in FIG. 6A (referred hereinafter as Case A2). As shown in FIG. 6A, in some embodiments, one or more ticket pockets 602 are vertically positioned in the dispensing system (not shown). In some embodiments, the dispensing system may include one or more dispensers 604 for dispensing the objects from the ticket pockets 602.

In some embodiments, one dispenser 604 may be associated with one or more ticket pockets 602. In some embodiments, one dispenser may be associated with 1 to 5 ticket pockets 602. In some embodiments, one dispenser may be associated with 2-4 ticket pockets 602. In some embodiments, one dispenser may be associated with 3 ticket pockets 602. In some embodiments, one dispenser may be associated with 5 ticket pockets 602 as shown on FIG. 6A.

In some embodiments, more than one ticket pocket/dispenser combination 610 may be installed in the dispensing system. In some embodiments, the one or more ticket pocket/dispenser combinations 610 may be positioned front to back and secured as shown in FIG. 6A thus reducing the depth of the dispensing system. In some embodiments, the configuration shown in FIG. 6A is referred to as a single battery (2 dispenser) configuration.

In some embodiments, the dispensing system may include 1-6 single battery (2 dispenser) ticket pocket/dispenser combinations 610 as shown in FIGS. 6B-6F. FIG. 6B shows a cross-section of an embodiment of single battery (2 dispenser) ticket pocket/dispenser combination 610. In some embodiments, the dispensing system may include 1-5 single battery (2 dispenser) ticket pocket/dispenser combinations 610. In some embodiments, the dispensing system may include 6 single battery (2 dispenser) ticket pocket/dispenser combinations 610. In some embodiments, the dispensing system may include 5 single battery (2 dispenser) ticket pocket/dispenser combinations 610.

In some embodiments, the one or more ticket pocket/dispenser combinations 610 may be secured to the body of the dispensing system via a hinge or equivalent (not shown) allowing replacement and/or replenishment of the objects as detailed above with respect to Case A1.

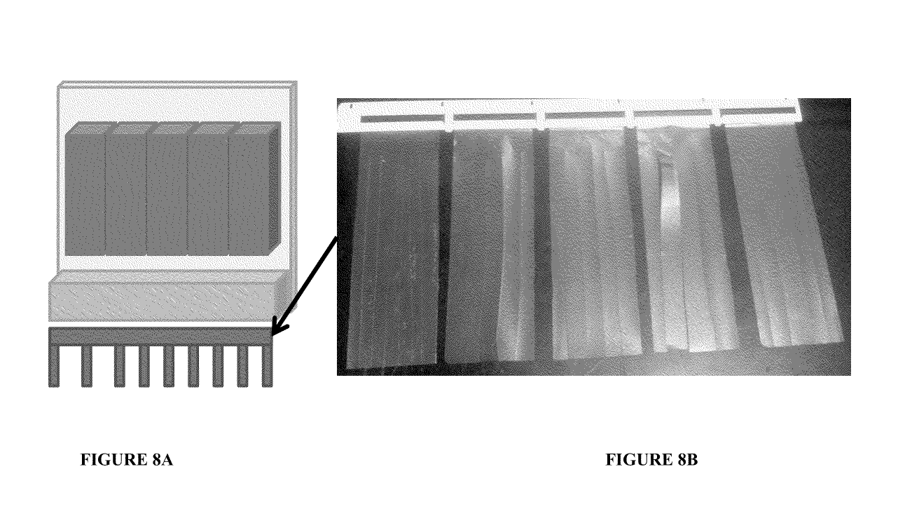

In some embodiments, FIGS. 7A and 7B show non-limiting paths of the tickets based on the ticket pocket/dispenser orientation associated with Cases A2 and A1, respectively. As shown in the figures, in some embodiments, the ticket pack stored in the ticket pocket is distributed over a redirection roller, along a pathway defined by a guiding roller, and into a dispenser for distribution through flexible, elastic “fingers” formed of any suitable material such as plastic. In some embodiments, FIGS. 8A and 8B show non-limiting examples of flexible “fingers” of an embodiment of the present invention.

In some embodiments, the ticket pocket/dispenser combinations may be configured so as to reduce and/or minimize the width of the dispensing system.

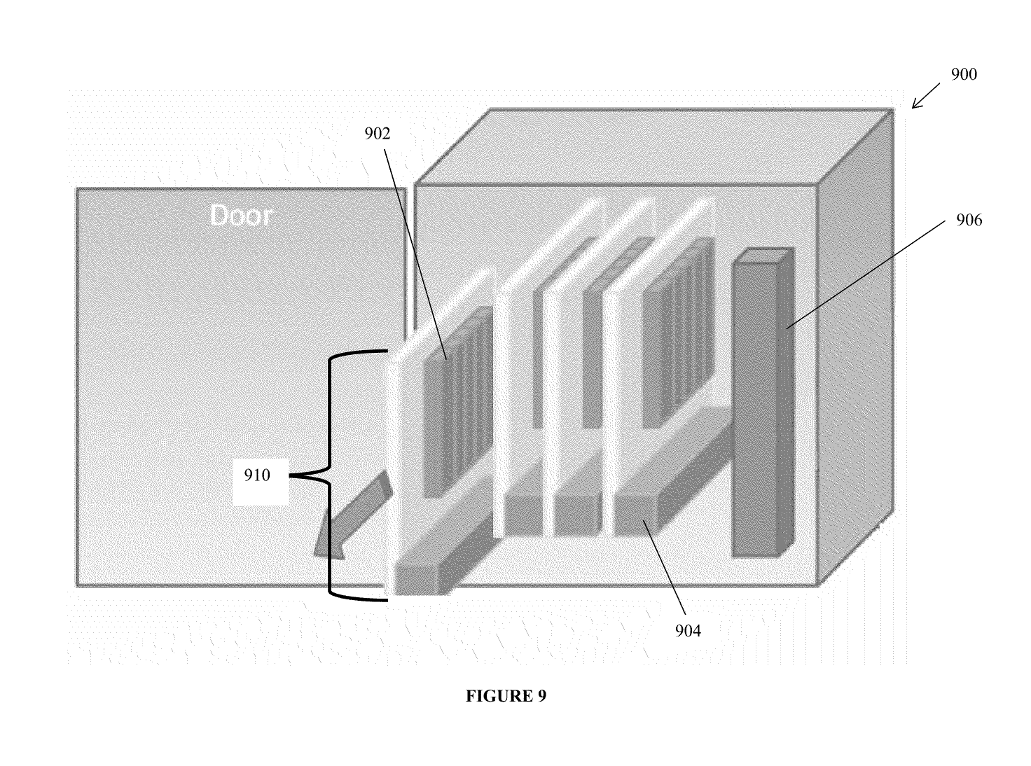

In some embodiments, the ticket pockets are positioned in the dispensing system as shown in FIG. 9 (referred hereinafter as Case B1). As shown in FIG. 9, in some embodiments, one or more ticket pockets 902 are vertically positioned in the dispensing system 900. In some embodiments, the dispensing system may include one or more dispensers 904 for dispensing the objects from the ticket pockets 902. In some embodiments, the dispensing system may also include a payment and validation device 906 configured for receiving payment for the objects.

In some embodiments, one dispenser 904 may be associated with one or more ticket pockets 902. In some embodiments, one dispenser may be associated with 1 to 5 ticket pockets 902. In some embodiments, one dispenser may be associated with 2-4 ticket pockets 902. In some embodiments, one dispenser may be associated with 3 ticket pockets 902. In some embodiments, one dispenser may be associated with 5 ticket pockets 902 as shown on FIG. 9.

In some embodiments, more than one ticket pocket/dispenser combination 910 may be installed in the dispensing system. In some embodiments, the one or more ticket pocket/dispenser combinations 910 may be positioned side by side (left to right or right to left) thus reducing the width of the dispensing system. In some embodiments, the dispensing system may include 1-6 ticket pocket/dispenser combinations 910. In some embodiments, the dispensing system may include 2-4 ticket pocket/dispenser combinations 910. In some embodiments, the dispensing system may include 2 ticket pocket/dispenser combinations 910. In some embodiments, the dispensing system may include 4 ticket pocket/dispenser combinations 910.

In some embodiments, as shown on FIG. 9, the one or more ticket pocket/dispenser combinations 910 may be extracted from the dispensing system as shown in FIG. 9 to facilitate replacement and/or replenishment of the objects. In some embodiments, the one or more ticket pocket/dispenser combinations 910 can be extraction from the dispensing system 900 by securing the ticket pocket/dispenser combination 910 and exerting a force in the direction of the arrow shown on FIG. 9.

In some embodiments, the ticket pocket/dispenser combinations may be configured in the dispensing mechanism so as to reduce and/or minimize the width and/or depth and/or length of the dispensing system. In some embodiments, various combinations of Cases A1, A2, and/or B1 may be used to reduce the width, depth, and/or length of the dispensing system. For example, a combination of case A2 and B1 (hereinafter referred to as Case B2) may result in improved footprint reduction compared with case A1, A2, and/or B1 alone.

In some embodiments, the system and method may result in a reduction in the dispensing system footprint—a reduction in the length, width and/or depth of the dispensing system. In some embodiments, multi-channel dispensing system constructed for traditional systems do not required redesign or a reduction in the dispenser's capacity for the system of the present invention. In some embodiments, the present invention allows for manufacturing uniformity for either normal or compact size dispensing mechanisms. In some embodiments, various configurations of dispensing systems will benefit from the system and method of the present invention.

In some embodiments, a non-limiting comparison of the traditional dispensing system and the various dispensing systems of embodiments of the present invention is shown in Table 1. Table 1 is based on a matrix of 4 to 6 dispensers with 5 ticket pockets associated with each dispenser

TABLE 1

| Characteristic | Traditional | Case A1 | Case A2 | Case B1 | Case B2 |
|---|---|---|---|---|---|
| Width (%) | 100 | 100 | 100 | 72 | 69 |
| Depth (%) | 100 | 77 | 67 | 97 | 97 |
| Footprint (%) | 100 | 77 | 67 | 70 | 67 |
| Dispensers | 6 | 4 | 6 | 4 | 6 |
| Reduction in | 0 | 23 | 33 | 30 | 33 |
| Footprint (%) | | | | | |

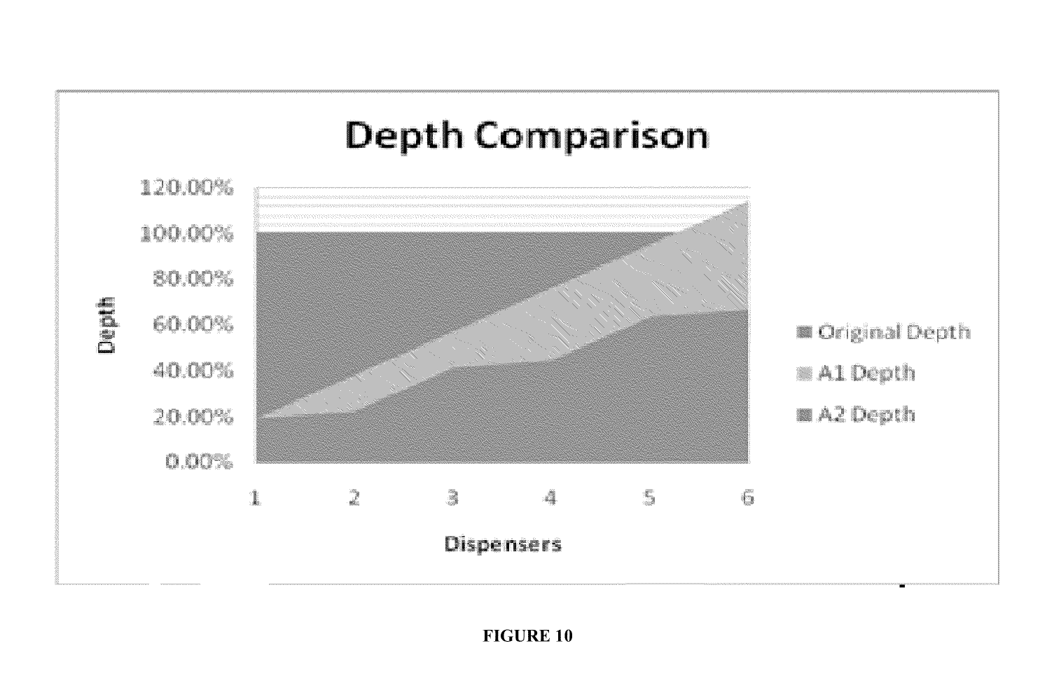

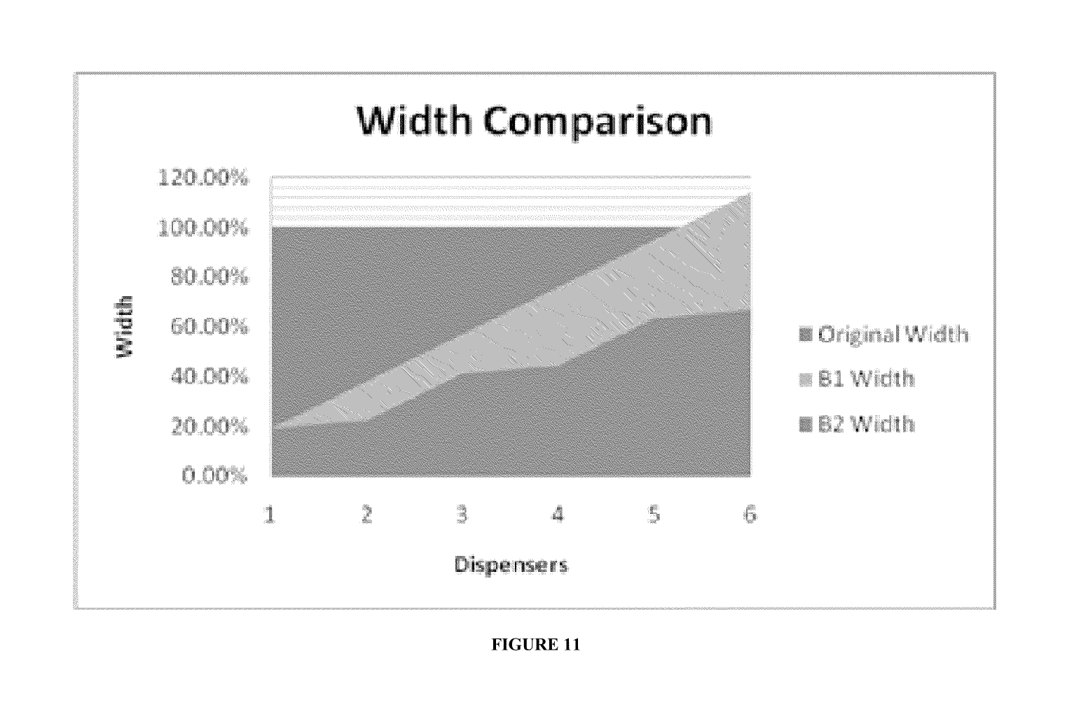

In some embodiments, a combination of A1/2-B1/2 results in the largest increase in capacity per unit area. In some embodiments, FIG. 10 shows a graphical comparison of the depth vs. number of dispensers of the traditional (referred to as original on FIG. 10) dispensing system and Cases A1 and A2 of embodiments of the present invention. In some embodiments, FIG. 11 shows a graphical comparison of the width vs. number of dispensers of the traditional (referred to as original on FIG. 11) dispensing system and Cases B1 and B2 of embodiments of the present invention.

In some embodiments, as shown on FIGS. 7A and 7B, the tickets are distributed beneath the dispenser where the “collecting bucket” overlaps with the dispenser's footprint. Thus, the space required in front of traditional dispensing systems to allow for the tickets to be distributed is eliminated from some embodiments of the present invention.

In some embodiments, the dispensing system is configured so that the time required for distribution of multiple tickets will be approximately equal. In traditional systems, the tickets positioned in an “upper” drawer farther from the dispenser requires a longer distance to reach the “collecting bucket” compared with tickets positioned in a “lower” drawer closer to the dispenser. Thus, the time required for distribution of multiple tickets varies for traditional systems. In some embodiments of the present invention, tickets travel about an equal distance to the “collecting bucket” due to the vertical orientation of the ticket pockets and thus are dispensed in about an equal time resulting in a relatively uniform dispensing time/response.

In some embodiments, the dispensing time of multiple tickets will not vary more than 10%. In some embodiments, the dispensing time of multiple tickets will not vary more than 7%. In some embodiments, the dispensing time of multiple tickets will not vary more than 5%. In some embodiments, the dispensing time of multiple tickets will not vary more than 3%. In some embodiments, the dispensing time of multiple tickets will not vary more than 2%. In some embodiments, the dispensing time of multiple tickets will not vary more than 1%. In some embodiments, the dispensing time of multiple tickets will not vary more than 5% to 10%. In some embodiments, the dispensing time of multiple tickets will not vary more than 1% to 5%. In some embodiments, the dispensing time of multiple tickets will not vary more than 3% to 8%.

In some embodiments, because the ticket pockets are vertical and the objects such as tickets are facing down, the distribution speed of the objects may be greater than the distribution speed of the traditional systems. In some embodiments, the increase in speed may result in disorderly distribution of the objects that may include ejection of the tickets from the dispense tray or bucket. In some embodiments, a flexible “finger” or film may be positioned at the ticket output location to reduce the speed—kinetic energy—of the ticket without the potential for the ticket “sticking” to the flexible “finger” and thus generating a jam. In some embodiments, FIGS. 8A and 8B show non-limiting example configurations of the flexible fingers. In some embodiments, the cuts, shape, and material of construction of the fingers may differ depending on the mechanical configuration of the dispensing system.

In some embodiments, the dispensing system is configured to allow for a change in footprint—length, width or depth—based on a constant object storage capacity. In some embodiments, the dispensing system is configured to allow footprint changes according to capacity and thus, be scalable in that respect with respect to the footprint.

In some embodiments, the dispensing system is configured to allow for ticket dispensing time to be about equal for all objects or tickets regardless of position in the ticket pockets.

In some embodiments, the dispensing system is configured for vertical ticket storage. In some embodiments, the dispensing system may include flexible fingers configured to reduce ticket speed.

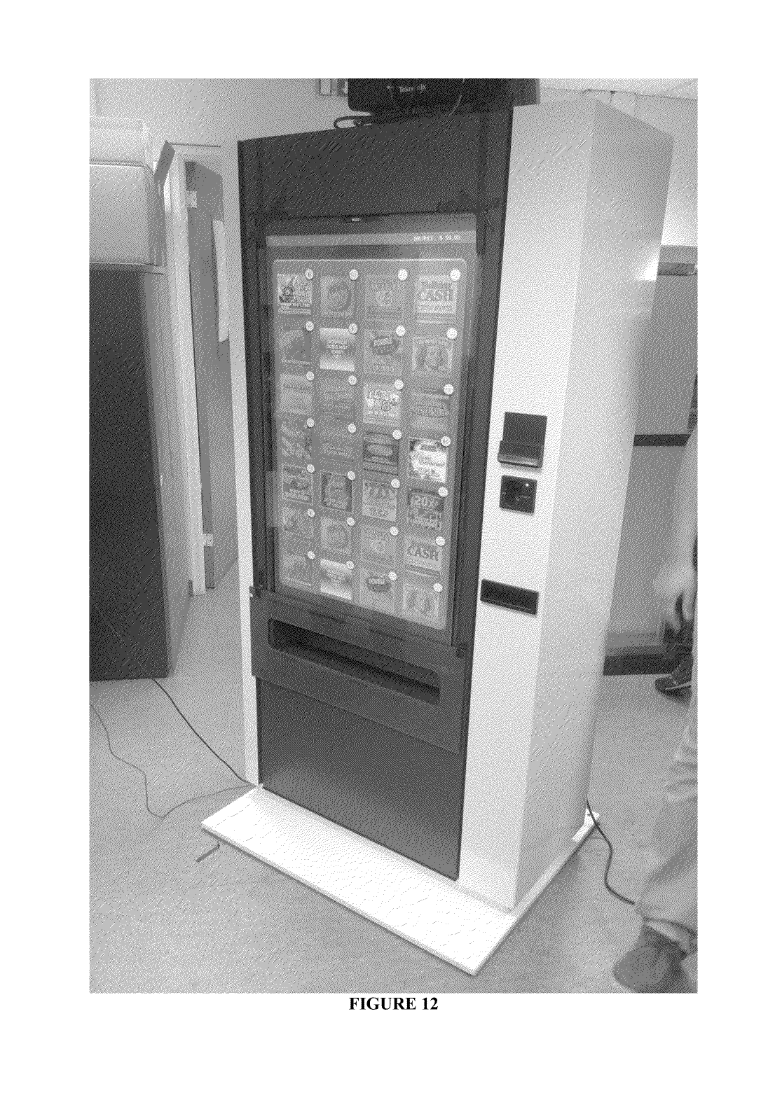

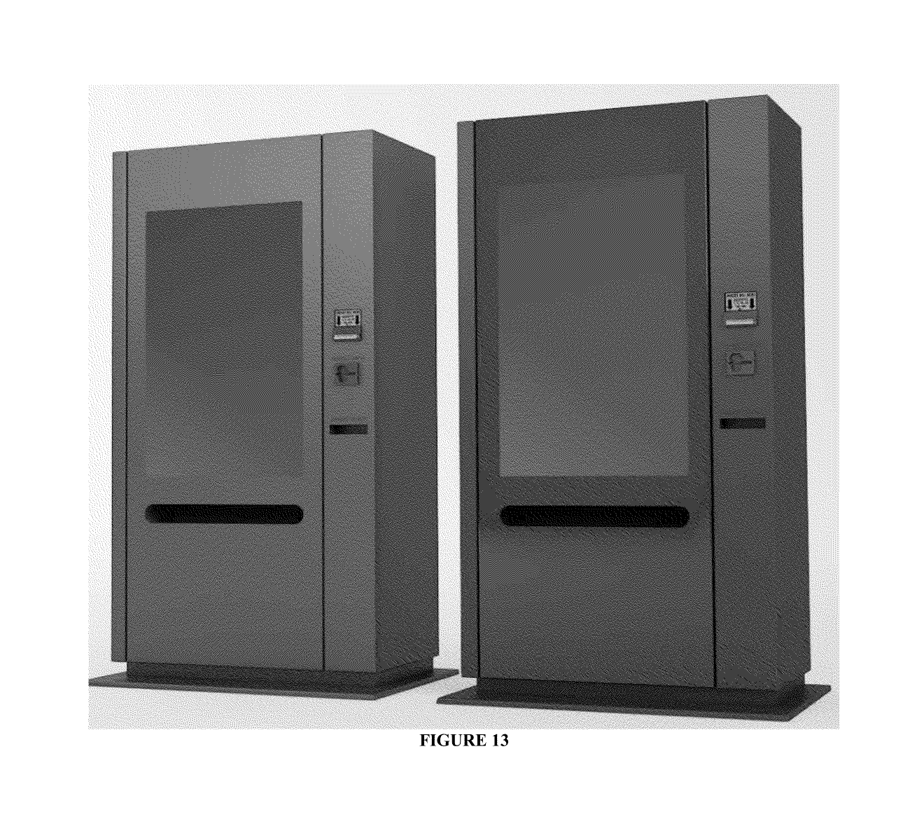

In some embodiments, the graphical user interface of the dispensing system may include, but is not limited to, a human face-to-face interaction. In some embodiments, the graphical user interface of the dispensing system may include, but is not limited to, graphical representations of objects such as instant lottery tickets as shown on FIG. 12. In some embodiments, the dispensing system is configured as shown on FIG. 13.

In some embodiments, the present invention is directed to a method that includes at least manufacturing a plurality of vending machines which are utilized to dispense a plurality of dispensing objects; where the manufacturing at least includes steps of: installing a first predetermined number of first pocket-dispenser combinations within a first interior of at least one first vending machine; where each first pocket-dispenser combination which at least includes: i) a first plurality of first pockets and ii) at least one first dispenser; where the first plurality of first pockets are vertically positioned during a dispensing operation of the at least one first vending machine so that: i) each of first pockets longitudinally extends along a first vertical axis of the at least one first vending machine, and ii) equal distances are maintained between bottoms of the first plurality of first pockets and the at least one first dispenser, where the bottoms of the first plurality of first pockets face down during the dispensing operation of the at least one first vending machine; where the first predetermined number is at least one; where a first length and a first width of a first footprint of the at least one first vending machine varies based on the first predetermined number of the first pocket-dispenser combinations to be installed within the first interior of the at least one first vending machine; installing a second predetermined number of second pocket-dispenser combinations within a second interior of at least one second vending machine; where each second pocket-dispenser combination which at least includes: i) a second plurality of second pockets and ii) at least one second dispenser; where the second plurality of second pockets are vertically positioned during a dispensing operation of the at least one second vending machine so that: i) each of second pockets longitudinally extends along a second vertical axis of the at least one second vending machine, and ii) equal distances are maintained between bottoms of the second plurality of second pockets and the at least one second dispenser, where the bottoms of the second plurality of second pockets face down during the dispensing operation of the at least one second vending machine; where the second predetermined number is at least one; where a second length and a second width of a second footprint of the at least one second vending machine varies based on the second predetermined number of the second pocket-dispenser combinations to be installed within the second interior of the at least one second vending machine; where, when the first predetermined number is equal to the second predetermined number, the first footprint is equal to the second footprint; and where, when the first predetermined number is different from the second predetermined number, the first footprint is different from the second footprint.

In some embodiments, the at least one first pocket-dispenser combination further includes at least: a first holding tray, a first subset of the first plurality of first pockets attached to a first side of the first holding tray, a second subset of the first plurality of first pockets attached to a second side of the first holding tray, the at least one first dispenser operationally associated with the first subset of the first plurality of first pockets, and at least one third dispenser operationally associated with the second subset of the first plurality of first pockets.

In some embodiments, the at least one second pocket-dispenser combination includes at least: a second holding tray, a third subset of the second plurality of second pockets attached to a first side of the second holding tray, a fourth subset of the second plurality of second pockets attached to a second side of the second holding tray, the at least one second dispenser operationally associated with the third subset of the second plurality of second pockets, and at least one fourth dispenser operationally associated with the fourth subset of the second plurality of second pockets.

In some embodiments, the dispensing objects are a first plurality of items selected from the group of lottery tickets, drawing tickets, game tickets, or any combination thereof.

In some embodiments, the first plurality of items includes a first subset of the first plurality of items to be dispensed by a first subset of the first plurality of first pockets, and a second subset of the first plurality of items to be dispensed by a second subset of the first plurality of first pockets; and where the first subset of the first plurality of items and the second subset of the first plurality of items are distinct items.

In some embodiments, the first plurality of items includes a first subset of the first plurality of items to be dispensed by a first subset of the second plurality of second pockets, and a second subset of the first plurality of items to be dispensed by a second subset of the second plurality of second pockets; and where the first subset of items and the second subset of items are distinct items.

In some embodiments, each first pocket-dispenser combination and each second pocket-dispenser combination are configured to be rotatable to facilitate an access for placing the plurality of dispensing objects into the first plurality of first pockets and the second plurality of second pockets.

In some embodiments, each first pocket-dispenser combination and each second pocket-dispenser combination further comprise flexible fingers.

In some embodiments, the present invention is directed to a vending machine which includes at least the following components: at least one pocket-dispenser combination within an interior of the vending machine; where the at least one pocket-dispenser combination comprises: i) a plurality of pockets and ii) at least one dispenser; and where the plurality of pockets are vertically positioned during a dispensing operation of the vending machine so that: i) each of the plurality of pockets longitudinally extends along a vertical axis of the vending machine, and ii) equal distances are maintained between bottoms of the plurality of pockets and the at least one dispenser, where the bottoms of the plurality of pockets face down during the dispensing operation of the vending machine.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A method, comprising:
manufacturing a plurality of vending machines which are utilized to dispense a plurality of dispensing objects;
wherein the manufacturing comprises:
installing a first predetermined number of first pocket-dispenser combinations within a first interior of at least one first vending machine;
wherein each first pocket-dispenser combination comprises:
i) a first plurality of first pockets and
ii) at least one first dispenser;
wherein the first plurality of first pockets are vertically positioned during a dispensing operation of the at least one first vending machine so that:
i) each of first pockets longitudinally extends along a first vertical axis of the at least one first vending machine, and
ii) equal distances are maintained between bottoms of the first plurality of first pockets and the at least one first dispenser,
wherein the bottoms of the first plurality of first pockets face down during the dispensing operation of the at least one first vending machine;
wherein the first predetermined number is at least one;
wherein a first length and a first width of a first footprint of the at least one first vending machine varies based on the first predetermined number of the first pocket-dispenser combinations to be installed within the first interior of the at least one first vending machine;
installing a second predetermined number of second pocket-dispenser combinations within a second interior of at least one second vending machine;
wherein each second pocket-dispenser combination comprises:
i) a second plurality of second pockets and
ii) at least one second dispenser;
wherein the second plurality of second pockets are vertically positioned during a dispensing operation of the at least one second vending machine so that:
i) each of second pockets longitudinally extends along a second vertical axis of the at least one second vending machine, and
ii) equal distances are maintained between bottoms of the second plurality of second pockets and the at least one second dispenser,
wherein the bottoms of the second plurality of second pockets face down during the dispensing operation of the at least one second vending machine;
wherein the second predetermined number is at least one;
wherein a second length and a second width of a second footprint of the at least one second vending machine varies based on the second predetermined number of the second pocket-dispenser combinations to be installed within the second interior of the at least one second vending machine;
wherein, when the first predetermined number is equal to the second predetermined number, the first footprint is equal to the second footprint; and
wherein, when the first predetermined number is different from the second predetermined number, the first footprint is different from the second footprint.

2. The method of claim 1, wherein the at least one first pocket-dispenser combination comprises:
a first holding tray,
a first subset of the first plurality of first pockets attached to a first side of the first holding tray,
a second subset of the first plurality of first pockets attached to a second side of the first holding tray,
the at least one first dispenser operationally associated with the first subset of the first plurality of first pockets, and
at least one third dispenser operationally associated with the second subset of the first plurality of first pockets.

3. The method of claim 1, wherein the at least one second pocket-dispenser combination comprises:
a second holding tray,
a third subset of the second plurality of second pockets attached to a first side of the second holding tray,
a fourth subset of the second plurality of second pockets attached to a second side of the second holding tray,
the at least one second dispenser operationally associated with the third subset of the second plurality of second pockets, and
at least one fourth dispenser operationally associated with the fourth subset of the second plurality of second pockets.

4. The method of claim 1, wherein the dispensing objects are a first plurality of items selected from the group of lottery tickets, drawing tickets, game tickets, or any combination thereof.

5. The method of claim 4, wherein the first plurality of items comprises:
a first subset of the first plurality of items to be dispensed by a first subset of the first plurality of first pockets, and
a second subset of the first plurality of items to be dispensed by a second subset of the first plurality of first pockets; and
wherein the first subset of the first plurality of items and the second subset of the first plurality of items are distinct items.

6. The method of claim 4, wherein the first plurality of items comprises:
a first subset of the first plurality of items to be dispensed by a first subset of the second plurality of second pockets, and
a second subset of the first plurality of items to be dispensed by a second subset of the second plurality of second pockets; and
wherein the first subset of items and the second subset of items are distinct items.

7. The method of claim 1, wherein each first pocket-dispenser combination and each second pocket-dispenser combination are configured to be rotatable to facilitate an access for placing the plurality of dispensing objects into the first plurality of first pockets and the second plurality of second pockets.

8. The method of claim 1, wherein each first pocket-dispenser combination and each second pocket-dispenser combination further comprise flexible fingers.

9. A vending machine, comprising:
at least one pocket-dispenser combination within an interior of the vending machine;
wherein the at least one pocket-dispenser combination comprises:
i) a plurality of pockets and
ii) at least one dispenser; and
wherein the plurality of pockets are vertically positioned during a dispensing operation of the vending machine so that:
i) each of the plurality of pockets longitudinally extends along a vertical axis of the vending machine, and
ii) equal distances are maintained between bottoms of the plurality of pockets and the at least one dispenser,
wherein the bottoms of the plurality of pockets face down during the dispensing operation of the vending machine.

10. The vending machine of claim 9, wherein the pocket-dispenser combination comprises:
a holding tray,
a first subset of the plurality of pockets attached to a first side of the holding tray,
a second subset of the plurality of pockets attached to a second side of the holding tray,
a first dispenser operationally associated with the first subset of the plurality of pockets, and
a second dispenser operationally associated with the second subset of the plurality of pockets.

11. The vending machine of claim 9, wherein the dispensing objects are a plurality of items selected from the group of lottery tickets, drawing tickets, game tickets, or any combination thereof.

12. The vending machine of claim 11, wherein the plurality of items comprises:
a first subset of the plurality of items to be dispensed by a first subset of the plurality of pockets, and
a second subset of the plurality of items to be dispensed by a second subset of the plurality of pockets; and
wherein the first subset of the plurality of items and the second subset of the plurality of items are distinct items.

13. The vending machine of claim 9, wherein the pocket-dispenser combination further comprises flexible fingers.
